(19) United States
(12) Patent Application Publication
(10) Pub. No.: US 2013/0175118 A1
(43) Pub. Date: Jul. 11, 2013

(54) DS-001 Full-Body Safety Harness

(71) Applicants: Edwin Eric McDonald, Durham, NC (US); Michael Lewis Schabow, Durham, NC (US)

(72) Inventors: Edwin Eric McDonald, Durham, NC (US); Michael Lewis Schabow, Durham, NC (US)

(73) Assignee: Bold Innovations LLC, Durham, NC (US)

(21) Appl. No.: 13/507,588

(22) Filed: Jan. 9, 2012

(51) Int. Cl. A62B 35/00

(52) U.S. Cl. 182/3

(57) ABSTRACT

A full-body safety harness that is to be worn by a user, especially a user in a hostile environment. Which such full-body safety harness comprises a torso surrounding portion with a D-ring for attaching a life line, two vertical shoulder straps, four straps that affixes to a pair of pants, and two leg supporting straps that clip around the legs. All portions of this safety harness extend over a portion of a person's body to retain the person within the full-body safety harness. The straps of this full-body safety harness are fabricated from a flexible material having an elastic extension in the range of 10%-25% under a tension load of approximately 100 newton's. This percentage of stretch of this full-body safety harness is controlled by additional static material that is stitched onto the straps in a controlled loop pattern.

### BACKGROUND OF THE INVENTION

Various occupations place people in precarious positions at relatively dangerous heights thereby creating a need for a fall arresting safety apparatus. Among other things such apparatus usually include the attachment of a safety line that can be used in various ways to provide fall arrest. Obviously such a harness must be designed to remain secure about the worker in the event of a fall. In addition the harness should arrest a person's fall in as safe a manner as possible placing a minimal amount of strain on the person's body. Yet another design consideration is to minimize the extent to which people may consider the harness uncomfortable and or cumbersome. Safety harnesses are commonly used as part of a fall protection system for persons subjected to the potential of a fall from a height. To achieve this in the workplace full-body safety harnesses are generally used. Such harnesses, which typically include shoulder straps, can be designed in many alternative manners.

Currently available full-body safety harnesses are generally manufactured from flexible, but relatively inelastic, woven materials such as nylon and polyester. Such materials are generally capable of an elastic extension of approximately 1% or less even under the tensile load of approximately 10 newton's. The afore mentioned materials generally exhibit an elastic extension of approximately 2.5% under max load capacity. Although the strength of such materials is suitable for fall protection, harnesses fabricated from such materials impair movement of a worker while in the harness. This impairment of movement often results in discomfort, reduced effectiveness and quick fatigue of the worker. The limited range of motion, discomfort and fatigue associated with current safety harnesses can result in safety lapses by the worker. Various attempts at redesigning safety harnesses to provide greater comfort and range of motion have met with very limited success. In other words, there remains a need for which an appropriate balance needs to be struck between user safety and user comfort. It is, therefore, very desirable to develop safety harnesses that does not suffer from such drawbacks.

### SUMMARY OF THE INVENTION

One aspect of the present invention is the provision of a full-body safety harness having relatively more elastic design with a controlled percentage of stretch while retaining the strength required providing the necessary safety. Another aspect of the current invention is the provision for straps that have a percentage of stretch extend over a portion of the person's body to retain the person within the full-body safety harness providing the necessary safety with comfort. The current invention is also designed with a D-ring position at chest level to provide a place for a safety line to be attached, and to provide a means to prevent undulating. At least a portion or section of the strap portion exhibits an elastic extension of at least 25% under a tensile load of approximately 20 Newton's. In addition to exhibiting the above elastic characteristics, the elastic strap portion(s) of the present invention must be capable of withstanding the tensile forces experienced in common use and in arresting falls, or an emergency situation. Preferably, the elastic strap portion(s) of the present invention will meet the maximum tensile strength necessary to handle any force including forces that reach max tensile strength.

These aspects are combined to form the preferred embodiment of the full-body safety harness constructed according to the principles of the present invention. The resulting combination makes the harness more comfortable during ordinary use while also ensuring user safety in the event of a fall, or an emergency situation. Thus the resulting harness has the characteristics of a class 3 safety harness. The configuration of the safety harness allows for easy donning, even allowing complete donning in less than a minute compared to other full-body safety harness that several minutes and even over an hour to assemble for proper use. The current invention is constructed with materials that are fire resistive. Additional features and or advantages of the present invention may become more apparent from the detailed description which follows.

### DESCRIPTION OF DRAWINGS

In the accompanying drawings, preferred embodiments of the present invention and preferred methods of executing the present invention are found in the following figures,

FIG. 1 is a close up view of a D-ring attached to the full-body safety harness

FIG. 2 is a close up view of a typical leg strap and fastener

FIG. 2.2 is a close up of how the static and elastic webbing is stitched together

FIG. 3 is a frontal view of the full-body harness as worn by a user

FIG. 4 is a back view of the full-body harness as worn by a user

FIG. 5 is a frontal view of a user wearing the full-body safety harness

FIG. 6 is a rear view of a user wearing the full-body safety harness

FIG. 7 is a side view of a user wearing the full-body safety harness

### PRESENTLY PREFERRED EMBODIMENTS

Preferred embodiment of the present invention and the components thereof constructed in accordance with the principles of the present invention are shown in the associated drawings, where like numerals represent like components throughout the various drawings.

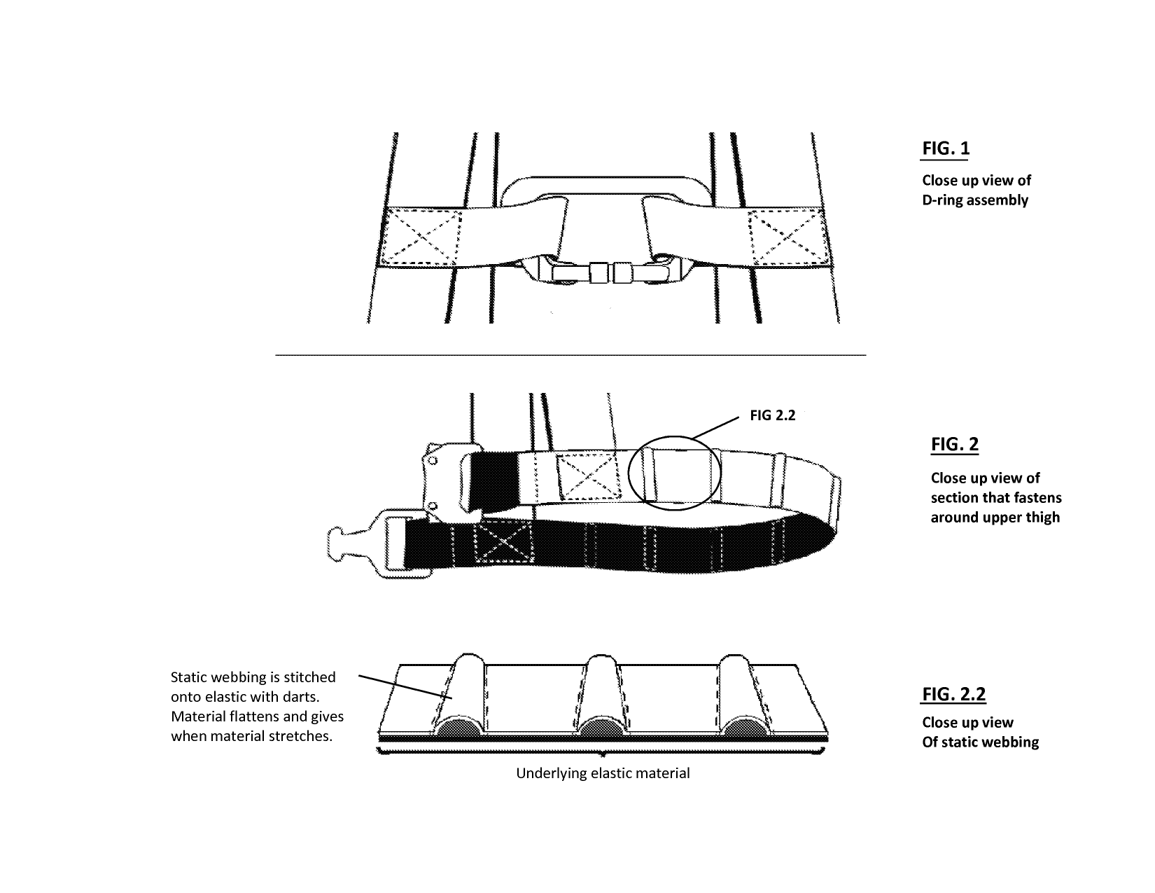

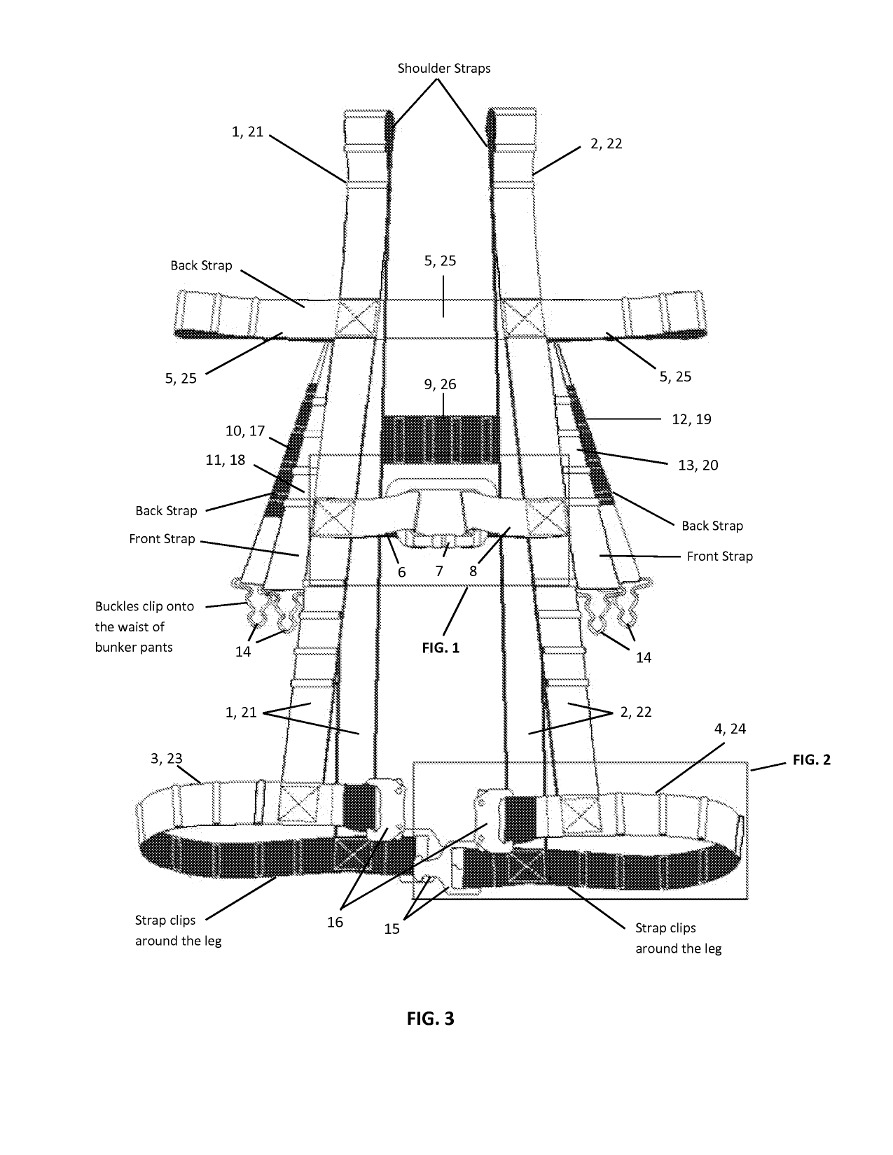

A preferred embodiment full-body safety harness constructed according to the principles found in the present invention is designated in FIGS. 1-4. The current invention is a full-body safety harness suitable for arresting the fall of a user, striking a balance between comfort and safety. FIG. 3 shows the preferred application of the present invention, wherein the current invention is worn by a user for safety.

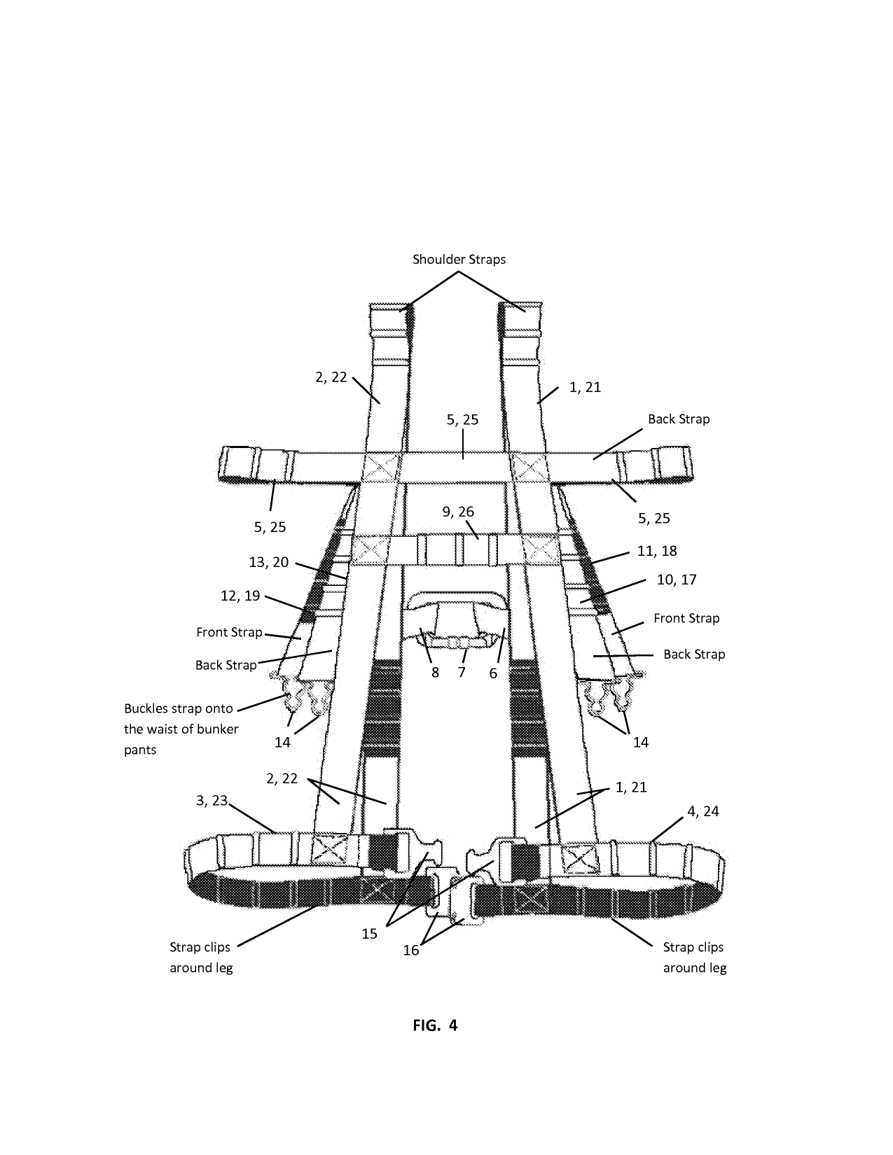

FIG. 3 shows a front view of the current invention. As demonstrated by FIG. 3 there are two shoulder straps; right (1, 21) and left (2, 22) preferably identical, and two leg straps (3, 23) and (4, 24) preferably identical. Each front and back of the shoulder strap is connected to each leg strap respectively by a stitching method, of a permanent nature, for securing the shoulder straps to leg straps as shown. The shoulder straps (1, 21) and (2, 22) are attached to a upper back support strap (5, 25) by a stitching method for securing both shoulder straps to the back support strap as shown. FIG. 1 shows an additional mid back support strap (9, 26) that is attached to the left and right shoulder straps by a stitching method for securing it as shown in FIG. 4. FIGS. 3 and 4 shows a D-ring is looped through 6 on the left and 8 on the right. Both 6 and 8 are attached to the respective left and right shoulder straps as shown.

FIGS. 3 and 4 shows pant straps (10, 17), (11, 18), (12, 19), and (13, 20) that are attached to the right (1, 21) and left (2, 22) shoulder straps by a stitching method. These four pant straps are for front and rear connection, on both right and left sides, to pants that require support in such a manner. These four pant straps are stitched to the area where the right and left shoulder straps are stitched to where the back support strap (5, 25) is connected as demonstrated in FIGS. 3 and 4. FIGS. 3 and 4 shows that all four pant straps have connected at one end of each pant strap, by a stitching method, pant clips that are used to hold up pants that require such assistance.

FIG. 2 shows detail of two half's 15 and 16 of a parachute buckle connected to the ends of the left leg strap (4, 24) and is secured by a stitching method. The same process will be repeated to connect the two half's 15 and 16 of the parachute buckle to the right leg strap (3, 23) and is secured by the same stitching method performed on the left leg strap. As shown in FIG. 2.2 the following straps; right (1, 21) and left (2, 22) shoulder straps, right (3, 23) and left (4, 24) leg straps, back (5, 25) support strap, additional back (9, 26) support strap, and pant straps (10, 17), (11, 18), (12, 19), and (13, 20) are made by a stitching method so that a static material (being the lower number) and an elastic material (being the higher number) are stitched together in the manner as shown.

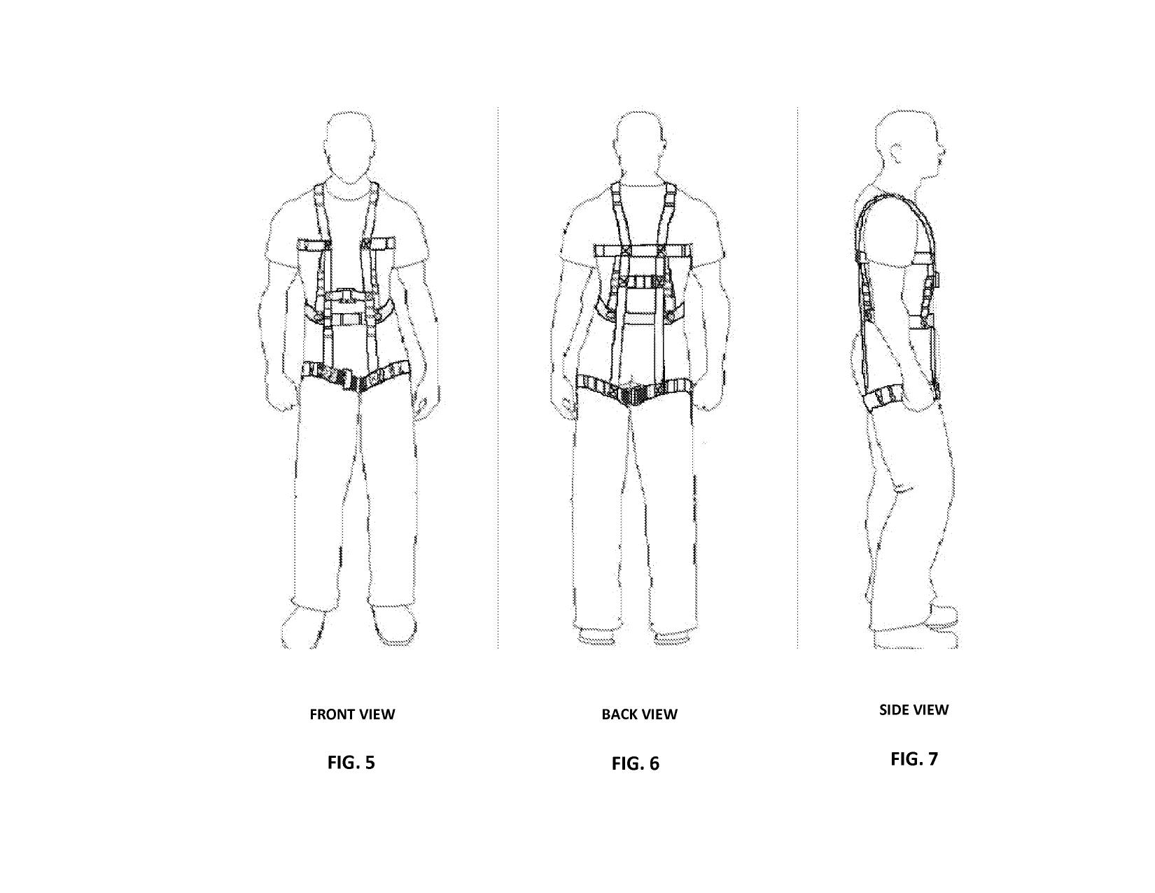

FIGS. 5-7 show various views of how the embodiment of the current invention as seen in FIG. 3 should be worn. FIG. 5 shows the proper placement of the D-ring 7, and of the right (3, 23) leg strap and the left (4, 24) leg straps. FIG. 6 shows the proper placement of the upper back support (5, 25) and of the mid back support (9, 26) straps. FIG. 7 shows the proper placement of the four pant clips 14 as needed.

1.) A full-body safety harness, comprising:
a.) A pair of shoulder straps, a pair of leg straps, a pair of back support straps, and connecting points for a D-ring.
b.) Made from static and elastic material that is stitched together
c.) To be worn by a user in any situation especially a safety situation that requires it

2.) The safety harness of claim 1 further comprises a removable D-ring for the purpose of attaching a safety line. Such D-ring is position in the current invention so that weight is evenly disputed across the body when using the safety line.

3.) The safety harness of claim 1 further comprises four heavy duty pant clips that can be used in connection with a variety of pant styles.

4.) The safety harness of claim 1 further wherein the left and right leg straps are attached to heavy duty parachute buckles by a stitching method.

5.) The safety harness of claim 1 wherein the left shoulder strap as one complete strap is fixedly connected to the independent left leg strap, and the right shoulder strap as one complete strap is fixedly connected to the independent right leg strap by a stitched method so that the left and right shoulder straps form a front and back respectively.

6.) The safety harness of claim 1 wherein pant straps are arranged 2 for front and 2 for back (4 total) are fixedly connected to the left and right shoulder straps respectively.

7.) The safety harness of claim 1 wherein contains a strap of static and elastic materials that is stitched together is half looped and fixedly connected to a leg strap so as to form a shoulder strap. This is accomplished for forming both the left and right shoulder straps respectively.

8.) The safety harness of claim 1 wherein both the upper back and mid back straps are fixedly connected to the left and right shoulder straps as expressed in the accompanying drawings.

9.) The safety harness of claim 1 wherein all pieces are stitched as shown in compliance with NFPA 1851 standard.

10.) The safety harness of claim 1 wherein all straps are made by stitching static webbing and elastic webbing together thus forming stretchable straps that retain the strength of the static webbing.
